(19) United States
(12) Patent Application Publication
(10) Pub. No.: US 2010/0009770 A1
(43) Pub. Date: Jan. 14, 2010

(54) GOLF CLUB AND METHOD OF DESIGN

(76) Inventor: Howard B. Sosin, Fairfield, CT (US)

Correspondence Address: CHOATE, HALL & STEWART LLP, TWO INTERNATIONAL PLACE, BOSTON, MA, 02110, US

(21) Appl. No.: 12/506,759

(22) Filed: Jul. 21, 2009

Related U.S. Application Data
(63) Continuation of application No. 11/401,619, filed on Apr. 10, 2006, now abandoned.
Application No. 11/401,619 is a continuation of application No. 09/248,515, filed on Feb. 8, 1999, now abandoned.

(51) Int. Cl. A63B 53/00; B23P 15/00

(52) U.S. Cl. 473/282; 29/592

(57) ABSTRACT

Disclosed is a golf club design and method of designing a golf club or a plurality of golf clubs encompassing irons, woods and putters for a golfer. The golf club includes a shaft joined to a club head with a hosel. The club head has a sole and a club face adapted to strike a golf ball. A lie, a design loft, a length and an offset for the club are typical design parameters of the club. When the club is oriented at its design loft, a lean angle, defined as the angle between (i) a projection of the centerline of the shaft onto a vertical plane, the plane being along an intended line of play and (ii) a vertical line in such vertical plane, is tailored based upon the design loft, at least one of the lie, length and offset of the club and at least one swing characteristic of the golfer. Such swing characteristics may include a location of the hands of the golfer upon impact of the club with a golf ball, an effective loft of the club, a location of the golf ball in the stance of the golfer when the golfer addresses a golf ball, a location of the hands of the golfer when the golfer addresses a golf ball, and a location of the hands of the golfer with respect to a location of a golf ball in the stance of the golfer when the golfer addresses a golf ball. The method of the invention disclosed herein may further include determining such swing characteristic of the golfer by using a trained observer and an automated observing system.

### BACKGROUND OF THE INVENTION

The present invention relates to golf clubs and methods of golf club design and more particularly to adjusting a certain golf club design parameter to improve club performance and to better suit an individual golfer's style of play.

As is commonly known in field of golf club design, there are three basic geometrical design parameters for golf clubs, namely, loft, length and lie. All conventional sets of golf clubs employ a range of each of these parameters in order to provide an assortment of clubs that can be used for various golf shots. The loft of the club is the angle of the club face relative to the sole of the club. The loft influences the angle of ascent of a struck golf ball and, accordingly, it is an important factor regarding the distance and trajectory of the shot. The loft of the club is also a factor in the backspin imparted on the struck golf ball. Higher lofted clubs are designed to produce more backspin than lower lofted clubs. The length of the club is normally measured from the end of the shaft to a plane defined by the sole of the club. The length influences the force with which the golf ball may be struck and thus has a significant effect on the distance of travel of the ball. And the lie of the club is the angle of the centerline of the shaft with the ground line tangent to the sole at the centerline of the face. The lie allows the length and the loft to be adjusted such that the golfer can swing the club and have the sole contact the ground on its center between heel and toe or as otherwise intended by the manufacturer of the club.

The rules of golf limit a golfer to 14 clubs, a mixture of irons, woods, and a putter. In a typical set of “iron” clubs, 2-iron through sand wedge, the loft varies from about 20 to 56 degrees (and there is usually about a 4 degree difference per club), the length varies from about 40 to 35 inches, and the lie varies from about 58 to 64 degrees. A typical set of “wood” (including metal wood) clubs includes a driver and any one or more of a 2-wood through 11-wood. The loft of a fairly typical driver ranges from about 7 to 12 degrees. Other more exotic woods, such as a 7-wood, have lofts as high as 20 degrees while certain specialty wood clubs have even higher lofts. In the typical set of wood clubs and iron clubs, the lowest lofted club is the longest and, as the loft increases, the length of the club decreases. Similarly, the lie of the club typically increases with decreases in club length.

Another parameter more recently introduced in field of golf club design is known as offset. The offset of a club is typically the measurement of the leading edge of the club relative to the hosel. By offsetting the shaft from the leading edge, almost always in the direction towards the target, the center of mass of the club head is placed behind the centerline of the shaft. It is generally thought that this design produces greater loft and face closure at impact. In addition, face closure at impact can cause more of a right-to-left trajectory (for right-handed golfers) thereby reducing the incidence of slicing the shot.

Despite these and other existing design parameters, there is a need for adjustment of another parameter to allow tailoring of a club or set of clubs to one or more swing characteristics of a particular golfer.

All golf club manufacturers produce golf clubs with a design loft. In principle, the design loft of the club is the angle at which the club face should strike the ball. Striking a ball with an “effective” loft that is different from the design loft occurs because not all golfers have the same swinging motion. Thus, although there are relatively standard design loft values for a given club (e.g., 28 degrees for a 5-iron), because every golfer has a different swing there is great variation from one golfer to another in the effective loft of the same club striking the golf ball.

In other words, the design loft of the club is not necessarily the effective loft that the ball sees when struck by the club. This may result in the “standard” 5-iron having an effective loft of a 4-iron (or a 6-iron). When one considers that the difference in design loft between consecutively numbered clubs is only about 4 degrees, a very small swing variation will have a dramatic impact upon the effective loft and may result in an effective 4-iron (or 6-iron) loft or even a 3-iron (or 7-iron) loft when, in fact, the golfer is using a 5-iron.

To take full advantage of the design features of the sole of the club, it is important that the golfer be in a position to choose (or choose not) to strike the ball at an effective loft that equals or at least approximates the design loft of the club. For example, the sole of a golf club is designed with a number of parameters in mind including width, curvature and bounce angle. If the club used by the golfer strikes the ball at an effective loft other than the design loft, the benefit of these design features may be inadvertently or intentionally diminished.

Additionally, a difference between the design loft and the effective loft may cause some golfers to adjust their swing (consciously or unconsciously) or to use a club other than the one designed for the particular shot they are about to hit. For instance, if a golfer frequently imparts an effective loft of a 4-iron to a 5-iron, the golfer may attempt to compensate by swinging more slowly to diminish the distance achieved by the shot. Alternatively, the golfer may switch to a 6-iron which may produce the desired effective loft but typically has less length and requires a harder swing. Either way, the golfer is shortchanged because the design and effective lofts do not match. A golfer should be able to use any club and have an effective loft that matches or at least approximates the design loft, if he or she so desires.

There are at least three swing characteristics that may cause effective and design lofts to deviate from each other. The first such swing characteristic is the actual location of the golfer's hands relative to the ball when the club head strikes the ball. If, for example, the golfer's hands tend to be ahead of the club head (and ahead of the ball when it is actually struck) the club face will tend to strike the ball with an effective loft that is lower than the design loft of the club. Similarly, if the golfer's hands tend to be behind the club head (and behind the ball when it is actually struck), the effective loft will tend to be higher than the design loft. Although other swing characteristics have an influence on effective loft, it is this characteristic, location of the golfer's hands relative to the ball at impact, that primarily controls the effective loft of the club.

The second swing characteristic that influences the effective loft is the location of the ball in the golfer's stance. A right-handed golfer who tends to play the ball forward (back) in his or her stance (i.e., towards (away from) the left armpit) will tend to-have an effective loft that is higher (lower) than the design loft. For example, when using a 5-iron, a golfer who plays the ball in the middle of his or her stance may strike the ball earlier in his or her swing and have a lower effective loft than another golfer, using the same 5-iron, who plays the ball in the very front of his or her stance.

The third swing characteristic that influences effective loft is the location of the golfer's hands when addressing the ball just before the swing begins. A golfer, by putting his or her hands forward (back) in his or her stance (again, for right-handed golfers, this means towards (away from) the left armpit), may cause the effective loft of the club to be higher (lower) than the design loft.

Additionally, most golfers have different swings for each club in their bag. These swing deviations are influenced by variation in length and lie between clubs. Therefore, the difference between effective loft and design loft for each club within a set (for the particular golfer) may vary. For many golfers, it may be beneficial to adjust the difference in effective loft relative to design loft for one or more clubs in his or her bag.

There appears to be little discussion of effective loft in the field of golf club design. U.S. Pat. No. 5,224,702 to Turner is directed to an offset hosel design for a golf club. The disclosure in Turner addresses wood clubs and includes a hosel located at the back of the club head away from the face and angled toward the face of the club head at a predetermined angle which allegedly aids in preventing slicing or hooking a golf ball. The base of the hosel is located at least 1.25 inches from the leading edge of the club. The hosel and the shaft are angled toward the face of the club up to 15 degrees from vertical. Modifying this angle might adjust the effective loft, but there is little or no discussion about such a feature or any benefit therefrom.

U.S. Pat. No. 4,804,148 to Maltby discusses removing material from a runner on the sole of a wood-type metal club head to adjust the face angle, lie and/or loft of the head. Maltby makes no mention of modifying any other portion of the club or club head and actually states that modification of the sole is sufficient to make the desired adjustments. Maltby makes no adjustment for effective loft.

Golf is a very difficult game. It can be made less difficult by tailoring individual golf clubs and sets of golf clubs to the particularities of an individual golfer. The standard club designs and design methods, however, make no account for the effective loft of a club for the individual golfer. Accordingly, there is a need for a golf club or a set of golf clubs designed with effective loft in mind. It is also clear that there is a need for designing a golf club or set of golf clubs with effective loft in mind for the individual golfer who will use the club or set of clubs.

### SUMMARY OF THE INVENTION

The present invention utilizes a lean angle in the design of a golf club to allow a golfer to customize the relationship between design and effective loft for one or more clubs in his or her bag.

The design loft of a club is often specified by the manufacturer. Using the design loft (or the angle defined by the design loft) it is possible to orient the sole of the club on the playing surface in the manner intended by the manufacturer. If the design loft is not specified, but the characteristics of the sole are specified (and hence the designer's intended orientation of sole to playing surface), the club can be grounded as intended and the design loft determined by measurement. If neither the design loft nor the appropriate sole characteristics are specified by the club manufacturer, the design loft of the club is the angle of the club face when the club is grounded and the shaft is in a vertical plane.

When the club is oriented at its design loft, the lean angle of the club is the angle between (i) a projection of the centerline of the shaft onto a vertical plane, the plane being along an intended line of play and (ii) a vertical line in such vertical plane. The lean angle of a typical golf club usually is not specified by the manufacturer but in most cases a lean angle of 0 degrees can be inferred. According to the present invention, the lean angle may be adjusted in a positive or negative direction based upon one or more of a number of different swing characteristics. The method of the present invention comprises determining the design loft and tailoring the lean angle of the club based upon such selections and a swing characteristic of the golfer. Tailoring the lean angle may be further based upon at least one of a lie, a length and an offset for the club. Such swing characteristics may include each of a location of the hands of the golfer upon impact of the club with a golf ball, an effective loft of the golf club, a relative difference between the design loft and an effective loft of the club, a location of the hands of the golfer when the golfer addresses a golf ball, a location of the golf ball in the stance of a golfer, and a location of the hands of the golfer with respect to a location of a golf ball.

The method of the present invention may further include repeating the selecting step and the tailoring step for a plurality of golf clubs, and substantially matching the particular swing characteristic across the plurality of golf clubs. The method of the invention disclosed herein may also include determining such swing characteristic of the golfer by using a trained observer or an automated observing system.

It is an object of the present invention to provide an improved method of golf club design.

It is another object of the present invention to provide a golf club having a lean angle tailored to a particular swing characteristic of the golfer using the club.

It is yet another object of the present invention to provide a method of designing a golf club to account for a particular swing characteristic of the golfer by tailoring the lean angle.

It is still another object of the present invention to provide a method of designing a set of golf clubs that allows the golfer to choose a location for the golf ball in his or her stance for each club in the set such that he or she achieves the designed relationship between design and effective loft for such club. Further, it is an object of the present invention to allow the golfer to locate the ball in his or her stance in the traditional manner (i.e., with the ball placed more towards the left armpit for progressively longer clubs), or in a substantially similar location between his or her left and right armpits for progressively longer clubs, or more towards his or her right armpit for progressively longer clubs and, if he or she so chooses, achieve any relationship between design and effective loft for each club.

### DESCRIPTION OF THE DRAWINGS

FIG. 1 is a front elevational view of a club face of a conventional golf club;

FIG. 2 is a side elevational view of a toe of the conventional golf club;

FIG. 3 is a side elevational view of the toe of the conventional golf club particularly depicting an effective loft different from a design loft;

FIG. 4 is a side elevational view of a golfer holding a conventional golf club in the traditional manner;

FIG. 4a is a top elevational view of the feet of a golfer with ball placement in the traditional manner;

FIG. 5 is a side elevational view of a golfer holding a conventional golf club with the hands of the golfer located towards the front of the golfer's stance;

FIG. 6 is a side elevational view of the toe of a golf club in accordance with the present invention;

FIGS. 7a, 7b and 7c are side elevation views of the golf club in accordance with this invention; and

FIGS. 8 and 9 are top elevation views of the golfer holding a golf club in accordance with this invention.

### DESCRIPTION OF CERTAIN PREFERRED EMBODIMENTS

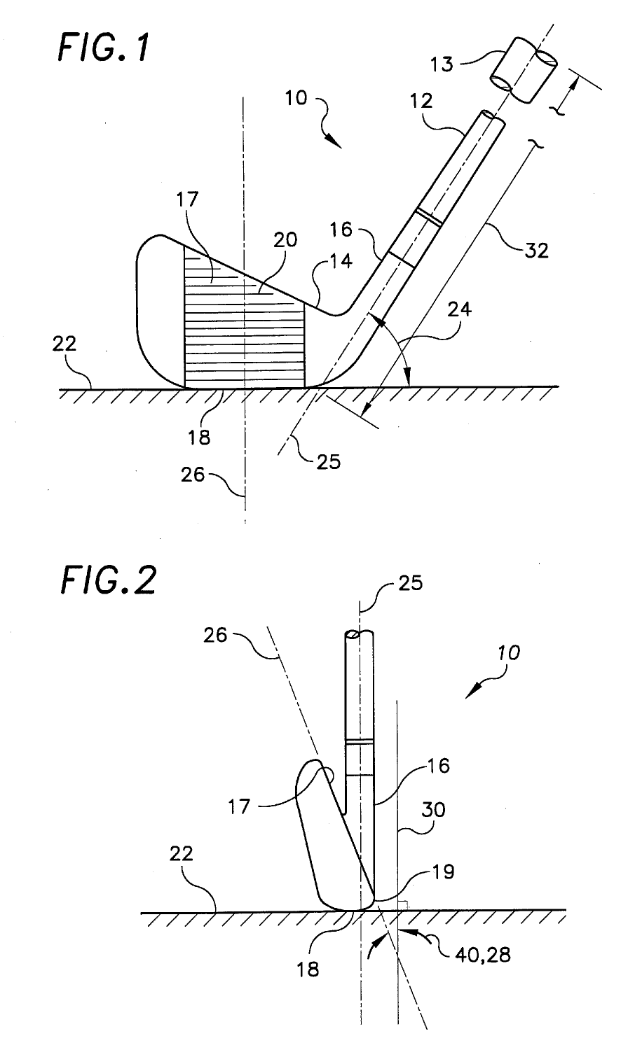

As seen in FIG. 1, a typical golf club 10 includes a shaft 12 and a head 14 joined together at a hosel 16. The shaft 12 terminates at a grip end 13. The head 14 of the club 10 includes a face 17 and a sole 18. The face 17 of the club is the surface of the club used to strike a golf ball and the sole 18 of the club is the bottom surface of the club. The face 17 normally has indentations or grooves 20 machined into the surface to impart spin on a golf ball struck by the club. Depending on a particular golfer's style of play, the sole 18 at its centerline 26 usually rests tangentially on a playing surface 22 when a golfer addresses a golf ball and at impact. As used herein, “golf club” means any implement used to strike a golf ball and includes irons, woods, metal woods and putters.

Lie 24 of the conventional club 10 is defined as the angle of a centerline 25 of the shaft with the playing surface 22 when the club rests on the playing surface 22 tangent to the sole 18 at a centerline 26 of the face 17. The range of lies for a typical set of irons (2-iron through sand wedge) is 58 to 64 degrees. The lie for a typical driver (1-wood) is in the 54 to 56 degree range, and 3-woods through 7-woods usually have a lie in the range of approximately 57 to 58 degrees.

Length 32 of club 10 is the distance measured along the shaft from the grip end 13 of the shaft 12 to the playing surface 22 with the playing surface 22 tangent to the sole 18 at the centerline 26 of the face 17. A typical set of irons has a range of lengths from about 35 to 40 inches. Wood clubs (which include metal-wood clubs) are typically longer than irons, and a driver will often have a length of about 43 to 46 inches. Other woods, such as a 3-wood, 5-wood and 7-wood, typically have a length of about 41 to 43 inches.

The design loft of a club is often specified by the manufacturer. Using the design loft (or the angle defined by the design loft) it is possible to orient the sole of the club on the playing surface in the manner intended by the manufacturer. If the design loft is not specified, but the characteristics of the sole are specified (and hence the designer's intended orientation of sole to playing surface), the club can be grounded as intended and the design loft determined by measurement. If neither the design loft nor the appropriate sole characteristics are specified by the club manufacturer, the design loft of the club is the angle of the club face when the club is grounded and the shaft is in a vertical plane.

A side view of club 10 is shown in FIG. 2. Here the sole 18 of the club is resting on the playing surface as intended by the manufacturer and, accordingly, the design loft 28 is the angle of the club face 17 along its centerline 26 relative to a line 30 perpendicular to the playing surface 22. Assuming that FIG. 2 also represents the impact position, the effective loft 40 will be substantially the same as the design loft 28. The range of design lofts for a typical set of irons (2-iron through sand wedge) is about 20 to 56 degrees. The design loft of a driver is usually between 7 and 12 degrees. The design loft of a 3-wood, 5-wood and 7-wood is usually about 15, 20 and 23 degrees, respectively.

The offset of club 10 is the distance from a leading edge 19 of the club 10 relative to the hosel 16. In FIG. 2 the offset is substantially zero inches. A typical offset, however, may extend up to 0.300 inches for irons and even more for woods. Usually, lower lofted clubs (i.e., 2-irons, 3-irons, etc.) have a greater offset than higher lofted clubs. Clubs with an offset tend to have a center of gravity that is behind the centerline 25 of the shaft. This “offset” center of gravity introduces a dynamic process during a golf swing that can encourage face closure at impact and may reduce a natural tendency to slice the golf ball.

The design lofts, lengths, lies and offsets discussed above are representative of a typical set of men's clubs; it is well recognized that these parameters usually vary for women's and children's clubs.

In addition to irons and woods, a set of golf clubs typically includes the putter. Although special rules apply to them, putters all have design lofts, lengths, lies and offsets like other clubs.

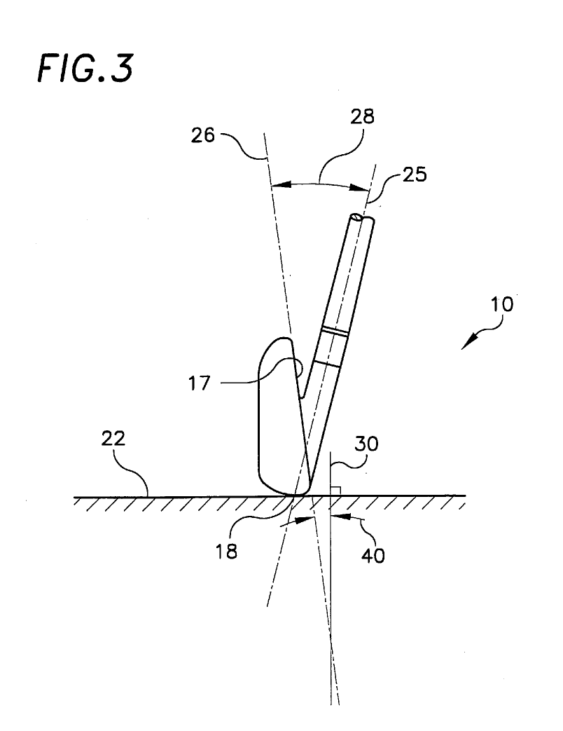

Turning now to FIG. 3, there is shown club 10 having the same design loft 28 as depicted in FIG. 2. However, the club 10 rests on the playing surface 22 tilted towards the target (not shown, but usually in front of and perpendicular to the club face 17). The sole 18 of the club does not rest on the playing surface as intended by the manufacturer, with the result being that the design loft 28 differs from the effective loft 40 (as depicted in FIG. 3, the effective loft is less than the design loft). As shown in FIG. 3, the effective loft 40 is the angle of the club face 17 on its centerline 26 relative to a line 30 perpendicular to the playing surface 22. The effective loft 40 is the loft the golf ball (not shown) sees when struck by the club. FIG. 3 can be viewed as either depicting the club when the golfer addresses the golf ball (i.e., when the golfer is standing over the ball, just before he or she commences his or her swing) or depicting the club in the middle of the swing at the point of impact with the ball (not shown). In either case, it is apparent in FIG. 3 that the effective loft 40 is different than the design loft 28 due to the orientation of the club relative to the playing surface 22. The loft differential (the amount by which the design loft 28 and the effective loft 40 differ) in FIG. 3 is just a few degrees, however, this can be significant in a golf shot where a 4 degree modification in loft can translate into approximately 10 to 20 yards of distance.

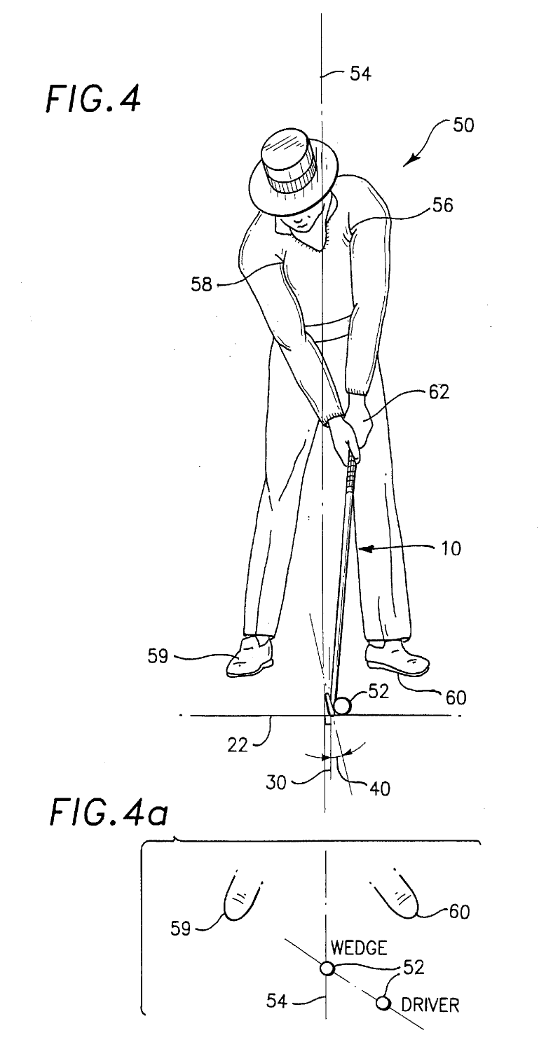

FIG. 4 depicts a golfer 50 addressing a golf ball 52 with a relatively standard or conventional stance. As shown, the hands 62 of the golfer 50 in the conventional stance are normally slightly ahead of body-center 54 and the location of the ball 52 is slightly forward of body-center 54. In other words, the ball is closer to the golfer's left armpit 56 than his or her right armpit 58. The conventional stance usually entails keeping the ball between body center 54 and the instep of the left foot 60.

Turning now to FIG. 4a, the conventional stance further entails locating the club head (when using the longest club in the golfer's bag, usually the driver) at the furthest point forward (towards the instep of the left foot 60) in the stance. The golf ball 52 is then moved backwards in the stance, towards the right foot 59 (but typically not past body center 54), and in towards the body of the golfer 50 for progressively shorter, higher lofted clubs such as a wedge.

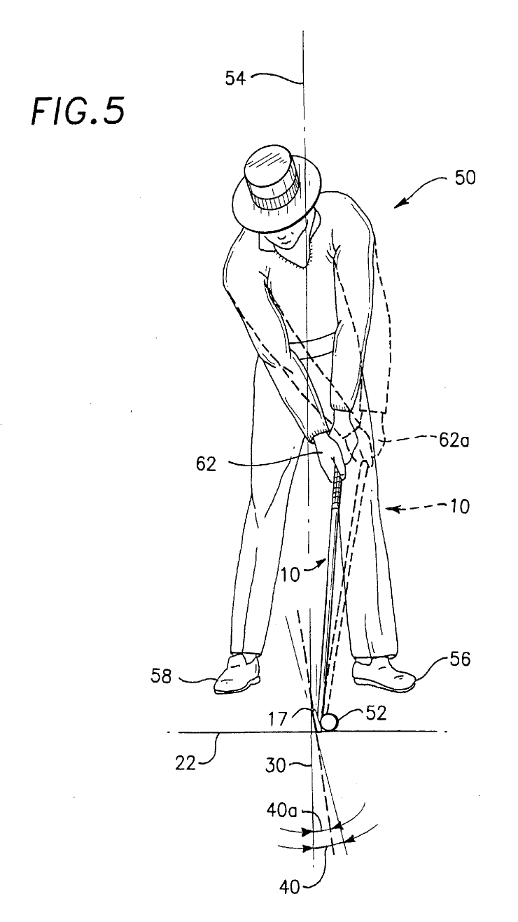

FIG. 5 depicts an alteration to the conventional stance. The position of the hands 62a of the golfer 50 are further forward relative to the hands 62 (also as shown in FIG. 4), while the location of the ball 52 is the same. This stance is relatively common and many golfers prefer to extend the position of their hands even further forward in their stance than is standard. However, the effective loft 40a of the club 10 may be modified by utilizing this different stance. While the design loft of the club remains constant, the effective loft 40, 40a of the club will depend on the location of the golfer's hands 62, 62a, when the ball is actually struck. With the hand location moved forward, the face 17 of the club 10 is closed towards the playing surface 22. This in turn changes the effective loft 40, 40a of the club. Again, although the difference is a few degrees (as depicted here, on the order of 5 degrees), it can mean the difference between landing on the green and ending up in a pond on the far side of the green.

FIGS. 4 and 5 also show the effect of hand location 62, 62a when the ball 52 is actually struck assuming now that FIGS. 4 and 5 represent the impact position. The location of the hands relative to the location of the ball when the ball is struck by the club primarily determines the effective loft 40, 40a of the club. The stance and the location of the ball in the stance have some influence on the resulting swing and the effective loft, however, the effective loft can be exactly determined only upon impact of the club and the ball.

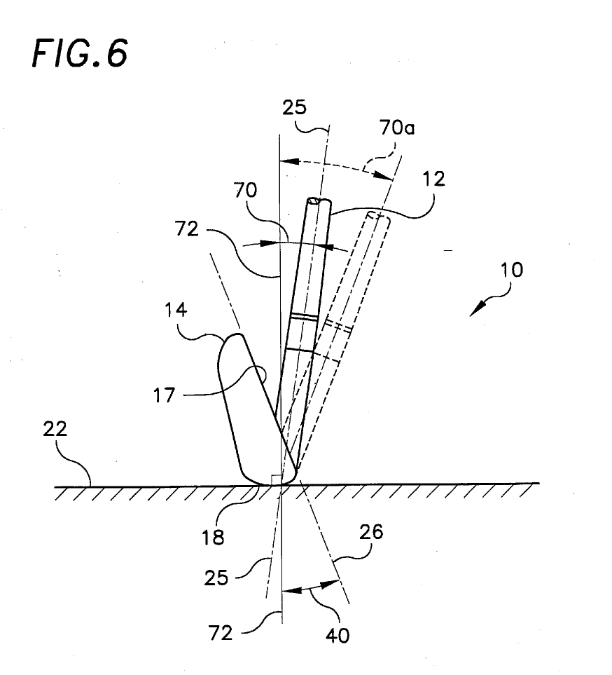

FIG. 6 depicts a golf club 10 designed in accordance with the present invention. When club is oriented at its design loft 40, the lean angle 70 of golf club 10 is the angle between (i) a projection of the centerline 25 of the shaft onto a vertical plane, the plane being along an intended line of play and (ii) a vertical line 72 in such vertical plane. Here the lean angle 70 is greater than zero. By modifying the lean angle 70, the relationship between the design loft 40 and effective loft of club 10 may be adjusted to better suit a particular golfer and one or more swing characteristics of the golfer.

As shown in FIG. 6, the lean angle 70 could be varied by up to 90 degrees on either side of line 72. It will be readily apparent to those skilled in the art that such a large lean angle is not only impractical, but may be against the rules of golf as published by the United States Golf Association. See paragraph 4-1b(ii) of Appendix II to the Rules of Golf, as approved by the United States Golf Association and The Royal and Ancient Golf Club of St. Andrews, Scotland, effective Jan. 1, 1998 (the “Rules of Golf”), and incorporated herein by reference. When “the club is in its normal address position”, such paragraph limits “the projection of the straight part of the shaft on to the vertical plane along the intended line of play” to no more than 20 degrees from the vertical. Thus, the Rules of Golf may limit the bounds of the lean angle 70 to no more than 20 degrees on either side of the line 72. It should be noted that the intended line of play is usually the direction in which the golfer is aiming. The intended line of play is typically perpendicular to the club face 17.

Regardless of the Rules of Golf, the preferred range for the lean angle 70 in accordance with the present invention is −15 (negative indicating a lean angle towards the right foot of a right-handed golfer relative to line 72) to 15 degrees (positive indicating a lean angle towards the left foot of a right-handed golfer relative to line 72), more preferably a range between 0 and 15 degrees, and even more preferably between 3 and 10 degrees.

In FIG. 6, the design loft 40 of the club 10 has already been determined. The lean angle 70 may be adjusted for a particular swing characteristic of the golfer. For example, if the golfer's hands tend to be the equivalent of about five degrees ahead of the club head 14 when the club head strikes the ball, the lean angle 70 can be adjusted from zero by a positive 5 degrees to compensate. A greater lean angle such as that indicated by reference numeral 70a may be used to further compensate and tailor the club to a swing characteristic of the golfer. This makes the club have an effective loft and a design loft that are substantially the same when the ball is struck at the club face. Similarly, if the golfer's stance, due to ball location, hand location, the relative difference between ball location and hand location, or otherwise, tends to produce an effective loft that is different than the design loft, then the lean angle 70 can be adjusted to make them similar or so that they have a relationship as desired by the golfer.

As described above, the swing characteristics may include any one or more of the following: the location of the hands of the golfer upon impact of the club with the golf ball, the effective loft of the club, a relative difference between the design loft and an effective loft of the club, the location of the golf ball in the stance of the golfer when the golfer addresses a golf ball, the location of the hands of the golfer when the golfer addresses the golf ball, and the location of the hands of the golfer with respect to a location of the golf ball in the stance of the golfer when the golfer addresses the golf ball.

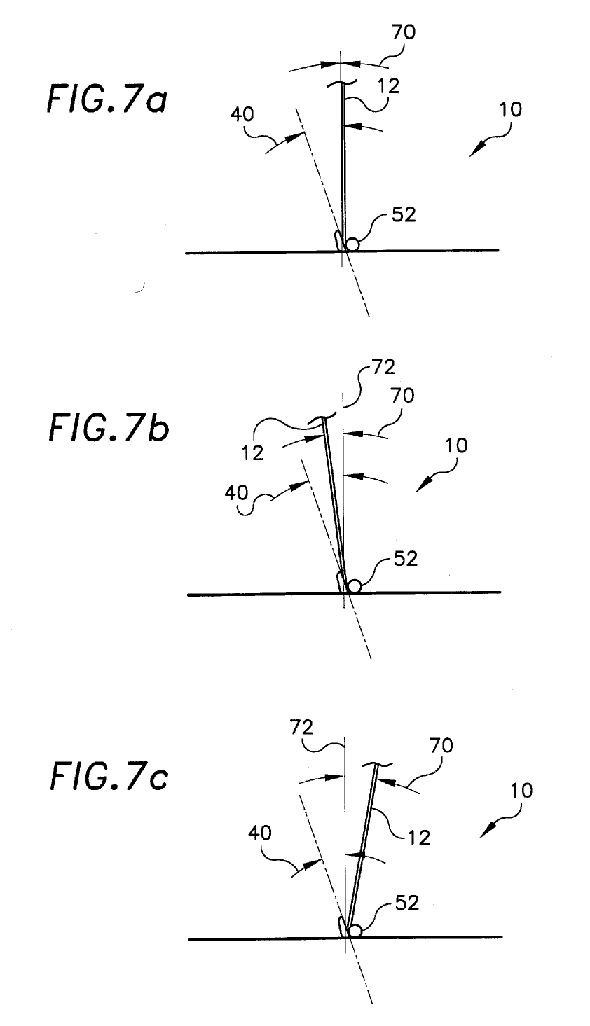

Turning now to FIGS. 7a, 7b and 7c, the design loft 40 of each club 10 is the same. The lean angle 70, however, of each club is different. In FIG. 7a the lean angle 70 is about 0 degrees, in FIG. 7b the lean angle is about −5 degrees and in FIG. 7c the lean angle 70 is about 10 degrees. Thus, if a golfer tends to keep the position of his or her hands over the ball 52, a lean angle 70 of about 0 degrees, as shown in FIG. 7a, may be best suited for this swing characteristic of this golfer. If, on the other hand, the golfer tends to keep the position of his or her hands behind or ahead of the ball, then a negative or positive lean angle 70, as shown in FIGS. 7b and 7c, respectively, may best suit this swing characteristic of this particular golfer.

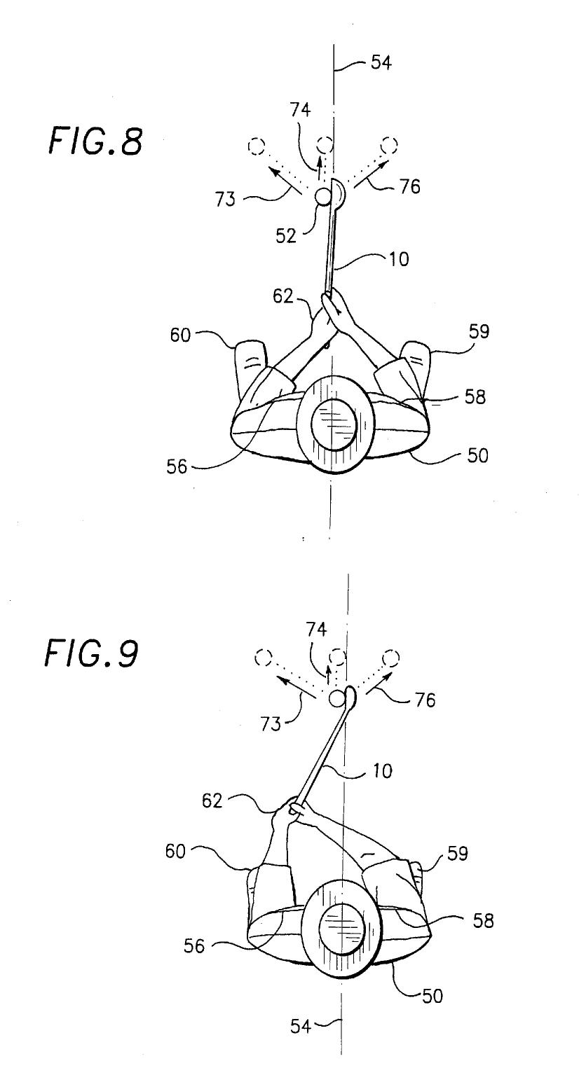

FIG. 8 shows an overhead view of the golfer 50 in his or her stance. A typical set of clubs and/or traditional instruction encourages or promotes the golfer to position the ball 52 to be close to body-center 54 for high lofted clubs such as, for example, a pitching wedge and to progressively locate the ball 52 in his or her stance towards his or her left armpit 56 for clubs with progressively lower lofts and greater lengths. Therefore, as the length of the club 10 increases, the typical set of clubs encourages the golfer to locate the ball in his or her stance generally along direction 73 (and not necessarily linearly). Thus, the golfer is forced to alter the location of the ball 52 with respect to his or her stance (i.e, the relative position between the left and right armpits) for each club in the set.

Golf is complicated enough without unnecessary variables. As the clubs get longer not only is the distance of the ball changing with respect to the golfer by necessity, but it is moving within the golfer's stance as well. By modifying the lean angle (not shown) as the length of the club increases, the location of the ball 52 with respect to any line approximately parallel to body center 54 may be kept constant. If the location of the ball moves along direction 74 as the length of the club increases, rather than along direction 73, the golfer may be able to utilize a more consistent golf swing and play a better round of golf. There also may be a benefit to adjusting the lean angle as the length of the club increases to encourage locating the ball 52 with respect to body-center 54 along direction 76, a direction that is backwards in the golfer's stance, away from the target.

FIG. 9 depicts a similar stance as in FIG. 8, except that the hands 62 of the golfer 50 are located towards his or her left armpit 56 and are generally ahead of the golf ball 52. Of course, the golfer could choose to locate his or her hands virtually anywhere, including body center 54, for any or all clubs, and further position the ball in his or her stance as he or she desires. Again, adjustment of the lean angle may allow (or encourage) the location of the golf ball to progress along direction 74 or 76, rather than the conventional direction 73, for progressively longer clubs. And, for that matter, modification of the lean angle provides for an infinite number of hand positions, ball positions and relative positions thereof, while maintaining a desired effective loft of the club.

Tailoring the lean angle 70 may be accomplished by using any of a number of conventional methods. For example, the clubs (including the hosel, if any, from which the shaft protrudes) can be manufactured from the outset with a particular lean angle (in fact, most clubs are manufactured with a lean angle of 0 degrees). The clubs can be specially manufactured with a specified lean angle to fit one or more swing characteristics of the golfer. The hosel can be manipulated or bent using conventional methods to alter the lean angle, or any combination of these methods may be employed.

Thus, a golf pro, a person trained in the art of golf club design or any other trained observer can improve a golfer's club(s) by tailoring the lean angle of one or more golf clubs based upon one or more of the aforementioned swing characteristics. A further aid in evaluating a swing characteristic and tailoring the lean angle to suit such characteristic is a video camera (not shown) or any other detection means including electronic sensors mounted to the golfer, the club or the ball, sensors located in space surrounding the golfer or any other conventional golf swing evaluation technique. The video camera may be connected to a processor to more precisely evaluate the swing characteristic and tailor the lean angle based upon such characteristic. A video camera, along with a slow motion processor, may be especially useful in detecting the effective loft of a golf club as used by a particular golfer when he or she strikes a ball. Although the flight pattern of the ball as it leaves the club face is complicated (see The Search for the Perfect Swing, by Cochran and Stobbs, Triumph Books, Chicago, 1996, pages 148-167, and incorporated herein by reference), it too can be used by an observer to evaluate the effective loft. By determining such effective loft and modifying the lean angle of the club to alter the effective loft to better suit the club to the golfer, an improved score cannot be far behind.

Any explicit or implied reference in the foregoing description to a right-handed golfer should be construed as applying equally, with appropriate modification, to a left-handed golfer. Additionally, it should be understood that the preceding is merely a detailed description of certain preferred embodiments. It therefore should be apparent to those skilled in the art that various modifications, alterations and equivalents can be made without departing from the spirit or scope of the invention.

I claim:

1. An iron-type golf club comprising:
a club head arranged during manufacture to have a face with a single design loft, a sole with a non-zero bounce angle, a selected offset and center of mass, and a straight hosel with a lean angle between 3 and 10 degrees that accepts a single straight shaft, wherein when the hosel is position at its lean angle relative to the vertical plane, the shaft is also positioned at the same angle relative to the vertical plane and the club head achieves its design loft relative to the vertical plane, its selected offset and center of mass, and its specified non-zero bounce angle relative to the horizontal plane.

2. A method of manufacturing an iron-type golf club head, the method comprising:
forming, during a manufacturing process a club head having a face with a single design loft, a sole with a non-zero bounce angle, a selected offset and center of mass, and a straight hosel with a lean angle between 3 and 10 degrees that accepts a single straight shaft, wherein when the hosel is position at its lean angle relative to the vertical plane, the shaft is also positioned at the same angle relative to the vertical plane and the club head achieves its design loft relative to the vertical plane, its selected offset and center of mass, and its specified non-zero bounce angle relative to the horizontal plane.
